(19) United States
(12) Patent Application Publication
(10) Pub. No.: US 2007/0090660 A1
(43) Pub. Date: Apr. 26, 2007

(54) Adjustable truck rack

(76) Inventor: Antonio Santiago Rios, Vallejo, CA (US)

Correspondence Address: John P. Luther;Jenkens & Gilchrist, Suite 2600, 225 W. Washington Street, Chicago, IL, 60606, US

(21) Appl. No.: 11/259,704

(22) Filed: Oct. 26, 2005

(51) Int. Cl. B60P 3/00

(52) U.S. Cl. 296/3

(57) ABSTRACT

The present invention provides novel adjustable truck racks for use with pickup truck beds, their method of manufacture and various methods of conducting business comprising the use of the novel racks.

### COPYRIGHT NOTICE

Copyright 2005 Antonio Santiago Rios. All rights reserved. A portion of the disclosure of this patent application/patent document contains material which is subject to copyright protection. The copyright owner has no objection to the facsimile reproduction by anyone of this document, or patent which issues therefrom as it appears in the U.S. Patent and Trademark Office files and records.

### FIELD OF THE INVENTION

The present invention relates generally to adjustable racks for use with pickup trucks, their method of manufacture and various methods of conducting business comprising the use of such racks.

### BACKGROUND OF THE INVENTION

There are many accessories currently available on the market for the ever-popular pickup truck and the many various makes and models of such trucks. Owing to the utilitarian nature of most of these trucks, many different products and methods have been developed to expand carrying capacity and to facilitate loading, particularly with aftermarket products.

For example, U.S. Pat. No. 6,573,849 discloses a modular rack for a pickup truck which utilizes a plurality of interchangeable preformed rack portions, some of the components of which are interconnected to each other to create a truck rack which is specifically sized for the truck of the purchaser. This rack is also characterized as able to be made shorter, longer, wider, or narrower as necessary to be correctly sized to fit a specific truck. However, this design is somewhat disadvantageous, in that transverse and interconnecting members must be changed as manufactured to accommodate different truck bed dimensions, with the only standardized components being an upper front portion and rear portion of the rack configuration. Such an arrangement calling for a manufactured custom fit for specific truck models can be unnecessarily expensive.

U.S. Pat. No. 5,143,415 describes another light-weight truck rack which can be disassembled, and which can also be assembled in different configurations of size and shape. As disclosed in this application, the truck rack comprises a number of components, including two rail tracks each of which are mounted on respective longitudinal sides of the open bed of a truck, with each track having a length dimension extending substantially the length of the longitudinal side, and with each track further provided with a slot extending the length of each track's length dimensions. There are also provided base members attached to each respective rail track by a locking knob arrangement which runs the length of the rail track on the sides of the pickup truck bed, and which track is said to be permanently mounted to the pickup truck side wall. As further described, the nut is designed to fit into the slots on the respective rail tracks to engage the edges of the tracks and to be slid into the proper position. Four elongated stanchions are inserted into holes or apertures in the base members, and four cross members, each composed of two parts that are telescopically engaged with one another, are connected to the stanchions by four corner members to form the shape and structure of the truck rack. Also required is a spring-loaded locking means for releasably locking each end of each of the stanchions and each end of the cross members in their respective apertures. Telescoping of cross members is accomplished by tubular receptors and tubular inserts held in place by spring push pins in receptor apertures to provide the desired length of a cross member(s) for a custom fit for a particular truck bed. While no doubt such a product may facilitate use with a variety of different sizes of truck beds, its construction is unnecessarily complex and expensive, as requiring several features, such as the track rails which can become jammed with debris and become unworkable, especially when exposed to outside elements. Permanent mounting of the tracks to a truck will also decrease the value of the vehicle over time.

Additional examples of truck racks may be found, for example, in U.S. Pat. Nos. 5,192,107; 5,692,791; 5,628,540; 5,061,000; 4,211,448; 2,947,566; 3,765,713; and U.S. Published Patent Application Nos. 2002/0163214 and 2004/0026945.

In view of the shortcomings of conventional pickup truck load racks, there therefore exists a substantial need for a fully-adjustable rack which is able to be fitted to virtually any model and make of pickup trucks, or any truck bed for that matter, and which is convenient in use, assembly and disassembly, and which does not permanently damage or change a vehicle or become part of it once installed, which may hinder the vehicle's resale value.

These and other objects are fulfilled by the present invention.

### SUMMARY OF THE INVENTION

In accordance with that above, the present invention provides an adjustable rack for use with truck beds, and which comprises a plurality of portions, comprising in its broadest sense at least four vertical posts, and optionally a plurality of such posts, transverse rail members and two longitudinal members comprising front and rear portions which are slidably and detachably connected in assembly and where all of said portions are detachably interconnected to each other when assembled, and also detachably connected to the pickup truck bed using the manufacturer's provided post hole apertures, and which may be sized to fit virtually any pickup truck, or any truck bed during assembly and installation, with respect to length, width, and height as desired. The inventive truck racks are completely portable, and may be installed and then removed from installation without any permanent change to a vehicle, such as to not affect its resale value in any way.

These and other features, aspects and advantages of the present invention are more fully described and will be more fully understood with reference to the following Detailed Discussion of Preferred Embodiments with accompanying drawings, examples and claims.

### BRIEF DESCRIPTION OF THE DRAWINGS

FIG. 1 is an exploded plan top view of a preferred embodiment of the inventive truck rack ready for installation to the bed of a pickup truck.

FIG. 2 is an elevational perspective view of a preferred embodiment of the inventive truck rack installed within the bed of a pickup truck.

FIG. 3 is an exploded rear plan view of the embodiment of the inventive truck rack shown in FIG. 1.

FIG. 4 is an exploded right hand side plan view of the inventive truck rack shown in FIG. 1.

FIG. 5 is an exploded right hand plan view of a preferred means of securing portions of the inventive truck rack to a pickup truck bed.

FIG. 6 is a see through perspective elevational view of another preferred embodiment of a means of securing portions of the inventive truck rack to a pickup truck bed.

### DETAILED DESCRIPTION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

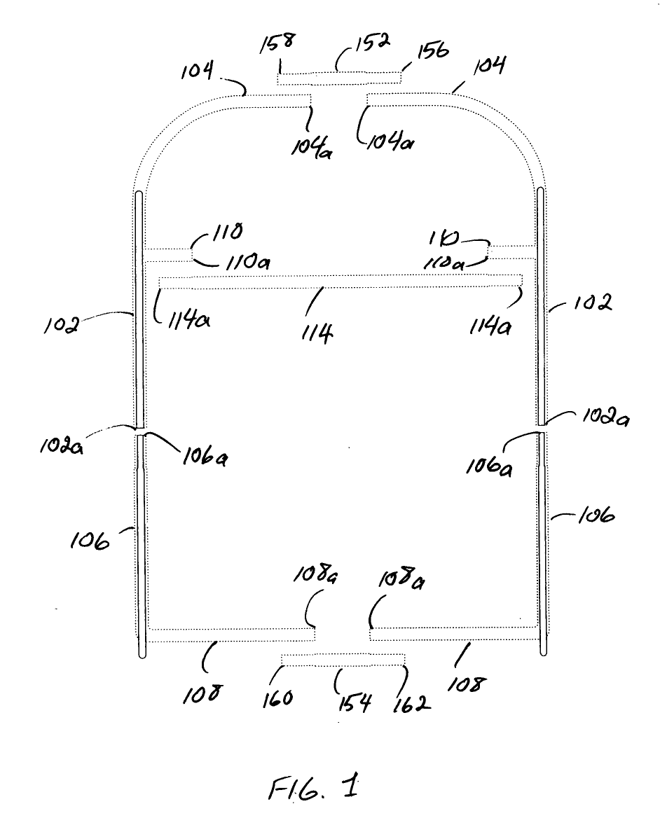

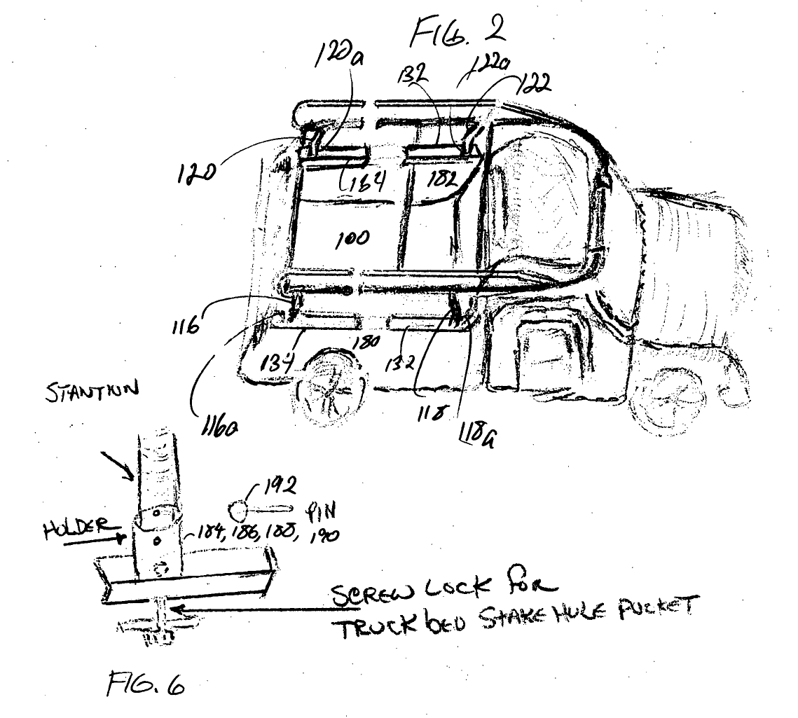

Having thus prefaced this discussion, attention is now directed to FIGS. 1 and 2 where there is illustrated a preferred embodiment of the inventive truck rack in an exploded view and ready for installation within the bed of a typical pickup truck and as installed within the bed of a pickup truck. As shown in FIG. 2, the truck rack installation employs post hole apertures provided within the lateral and longitudinal side walls of the truck bed as manufactured. The pickup truck in FIG. 2 is shown in broken lines, such as to not interfere with a description of the invention. Turning again to FIG. 1, in this embodiment, the inventive rack is composed of a plurality of portions, of which in an unassembled state comprise identical left and right hand top front longitudinal side portions (102), of which each is equipped with identical integral front portions (104) and identical left and right hand top rear longitudinal side portions (106), slidably detachable to the rear ends (102a) of the front longitudinal side portions (102), of which each is equipped with identical integral rear portions (108). Front portions (104) and rear portions (108) are transverse, or substantially transverse, to each respective integral longitudinal side portion (102, 106), and in which said longitudinal side portions (102) (and optionally side portions (106)) are optionally equipped with inwardly-directed inserts (110) for detachably connecting to each an additional transverse member (114) (or there may be a plurality of such additional inserts and transverse members depending upon such factors as the degree of load bearing weight contemplated, which are not shown).

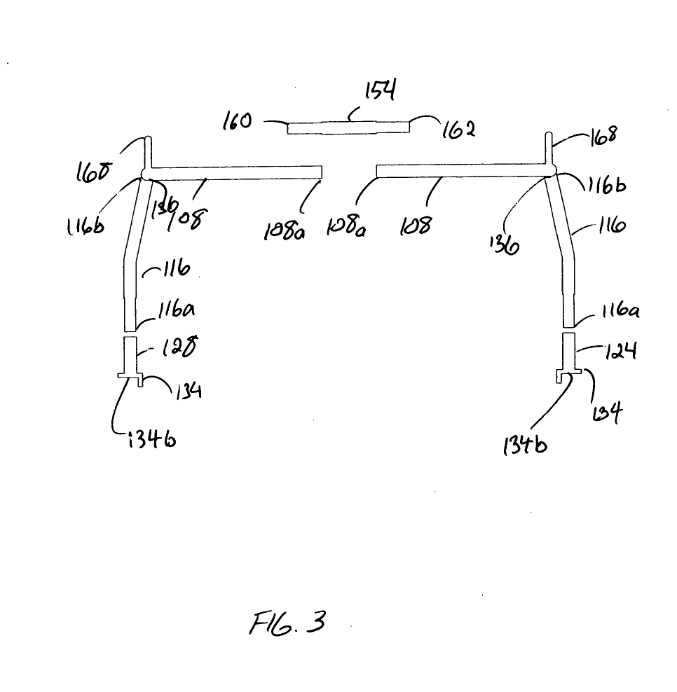

As shown in FIGS. 2, 3 and 4, there are also at least four vertical members (116, 118, 120, 122) which are insertable and securable at their respective bottom ends (116a, 118a, 120a, 122a) in respective apertures (124, 126, 128, 130) situated in identical bottom front and rear longitudinal side portions (132, 134) enclosing the truck bed (100). Front and rear longitudinal side portions (132, 134) are securable to the top of the truck longitudinal side walls at post holes, and which post hole apertures are standard features in most commercially produced pickup trucks. Optionally, a pair of said vertical members (116, 118, 120, 122) may each be detachably connectable to respective top front and top rear longitudinal side portions (102, 106) at their respective top ends (116b, 118b, 120b, 122b), here shown in FIG. 4 as a pair of vertical members (116, 118) detachably connectable to respective bottom portions (136, 138) of the right hand top front and top rear longitudinal side portions (102, 106).

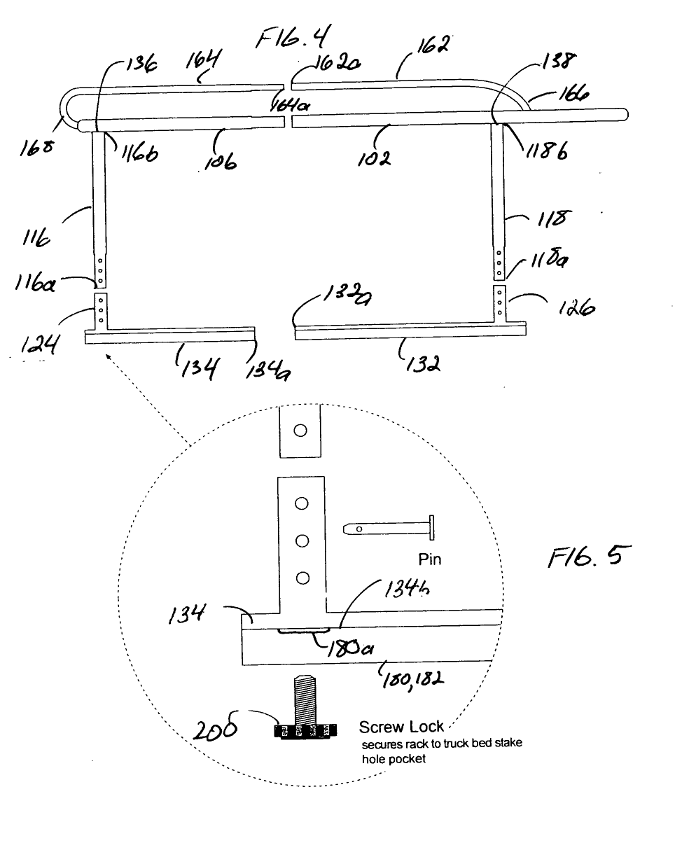

As further shown in FIG. 1, respective rear portions (102a) of longitudinal top front side portions (102) are slidably, detachably connectable, such as by a tubular insertable arrangement releasably lockable by, for instance, spring pin means, to respective front portions (106a) of top rear longitudinal side portions (106). Transverse and spacing front (152) and rear (154) inserts are, respectively, slidably, detachably connectable, such as by a tubular insertable arrangement with locking means described above, at each of their respective ends (156, 158, 160, 162) with respective ends (104a) and (108a) of integral transverse front and rear portions (104, 108) for provision of an adjustable fitting arrangement with a particular size truck bed. There may optionally be one or more (one shown) transverse members (114) slidably, detachably connectable, again, for instance, by a tubular insertable arrangement, by way of ends (114a) to integral inserts (110) ends (110a) situated in portions of top front and/or rear longitudinal side portions (102 and/or (106)). As also shown in FIG. 5, each longitudinal side portion (102, 106) may optionally be equipped with a respective additional identical left and right hand longitudinal side portion (162, 164) situated above and integral therewith by vertically, or substantially vertically, extending respective members (166, 168), and which may function as guard rails for transporting loads. Longitudinal side portions (164) will have respective front portions (164a) and longitudinal side portion (162) will have respective rear portions (162a), and which are slidably, detachably connectable to each other, such as by a tubular insertable arrangement, to one another in installation.

As shown in the installed truck rack embodiment of FIG. 2, the respective rear portions (102a) of the top front longitudinal side portions (102) are slidably and detachably connected to respective front portions (106a) of top rear longitudinal side portions (106) and locked in place by suitable locking means, such as a releasably locking spring-pin arrangement, and the respective rear portions (162a) of the additional top front longitudinal side portions (162) are slidably and detachably connected to the respective front portions (164a) of the respective top rear additional longitudinal side portions (164), and also locked in place by suitable locking means such as above described, with each respective bottom end portion (116a, 118a, 120a, 122a) of vertical members (116, 118, 120, 122) inserted and secured within respective apertures (124, 126, 128, 130) in the bottom longitudinal side portions (132, 134) which enclose the truck bed (100).

As also shown in the preferred embodiment of FIG. 5, bottom front and rear longitudinal side portions, respectively (132, 134), may be secured, along with the entire fitted and assembled above-described rack, to the tops of pickup truck longitudinal side walls (180, 182) via post holes apertures (180a, 182a) provided with the truck as manufactured, which at least four, one on each of the front and rear portions of the right and left hand truck longitudinal side walls being being substantially universally provided. Here the bottom portions (132b, 134b) of longitudinal side portions (132, 134), preferably at points where apertures (124, 126, 128 and 130) integrally intersect on their top sides, are attached to post holes (180a, 182a) by screw lock (200), insertable through holes (180a, 182a) into the bottoms (182b, 134b) of front and rear longitudinal side portions (132, 134) and tightened and secured via screw action. Any other suitable locking arrangement may also be used.

Thus, as shown, in installation and assembly, no matter what size of truck bed encountered, a front portion of the inventive truck bed rack may be secured to the provided apertures of a truck bed sidewall by way of vertical members, with a rear portion aligned and secured by way of vertical members to provided apertures of a truck bed sidewall, and the rear portion thereafter slidably engaged and locked in position with the front portion and with vertical members thereof secured in position to respective apertures, with one or more optional transverse supports slidably engaged and locked into position for the desired load bearing support contemplated. The minimal amount of parts required provide for an ultra simplistic and easy to use, highly functional truck rack, and which may be assembled and disassembled and stored in a flash when not needed.

As additionally shown in FIG. 6, a preferred embodiment of securing vertical portions (116, 118, 120, 122) about apertures (180a, 182a) is illustrated. Here, each respective vertical portion (116, 118, 120, 122) or stanchion may be slidably fitted over or within respective rack mounts (184, 186, 188, 190) (only one shown 184), such as by a tubular insertable arrangement with the inserted portions being the respective bottom ends (116a, 118a, 120a, 122a) of the vertical members (116, 118, 120, 122) and locked in place by suitable locking means, such as by releasable lockable spring pins (192) as illustrated in this preferred example. Each rack mount (184, 1816, 188, 190) (only one shown) is securable on a truck longitudinal sidewall or portion (180, 182) post hole aperture (180a, 182a) by suitable securing means.

In other preferred embodiments, a vertical member or stanchion may be inserted into a holder means and secured by any suitable means, such as by a spring loaded pin or screw means, or other releasable means for assembly and installation of the inventive rack products, and the holder means into which the stanchions are inserted and secured may be itself secured in or around the manufacturer provided post holes or apertures by an integral or attached elongated member extending through the aperture to which its unattached end as extended through the aperture is attached to a transverse member, which when tightened by way of threaded screw means will hold the holder to the surface of the truck bed longitudinal side wall area surrounding the aperture periphery in a secure and non-moveable fashion, and readied for the placement and securing of stanchions and completion of the installation of the inventive truck rack.

Further preferred features of a preferred embodiment of the inventive truck rack as installed in a truck bed are shown in FIG. 2 and FIG. 5. As one may ascertain, in the preferred embodiments illustrated herein, the front portion (104) integral with the top front longitudinal side portions (102), as shown in an assembled and installed mode in FIG. 2, feature an overcab assembly, which is able to accommodate additional load requirements as desired or contemplated. Such is only one of many possible preferred features and variations of the inventive truck racks, and may be eliminated if a reduced size of rack is desired, such as to accommodate a more compact storage facility, as the case may be.

The inventive racks described herein may be fabricated from any suitable material, such as steel of any suitable grade, or other suitable metals, or perhaps from a variety of composite materials, such as reinforced resins and the like, or even reinforced plastics or composites thereof, depending upon load bearing and rigidity requirements as desired and contemplated.

In yet an additional aspect of the invention, the inventive truck racks and methods for their manufacture and use afford distinct business advantages not previously available to vendors and other business-minded entities. In this respect, the present invention provides novel methods of conducting a wide array of traditional business functions comprising, inter alia, designing, manufacturing, using, marketing, selling, licensing and/or leasing the inventive subject matter, of developing business good will with the use thereof, of developing valuable trademark rights in conjunction with the use thereof, and further in providing subject matter for novel methods of business entity formation, such as partnerships, corporations, joint ventures and other collaborations for the purpose of exploiting the business of the inventive subject matter.

While this invention has been described in connection with what is presently considered to be the most practical and preferred embodiments, it is to be understood that the invention is not to be limited to such disclosed embodiments in any way, as such are merely set forth for illustrative purposes only. The present inventive products, methods of manufacture and use and methods of conducting business therewith are intended to cover an array of various modifications and equivalent arrangements, all of which are contemplated for inclusion within the scope and spirit of the disclosure end appended claims.

What is claimed is:

1. An adjustable rack assembly for use with a truck having truck bed longitudinal and lateral sides and a cab, and in which the truck bed longitudinal sides are equipped with apertures for receiving insertable members, said rack assembly comprising:
a plurality of vertical members with each having top and bottom end portions;
right and left hand longitudinal side portions, with each having front and rear portions, and with each respective front and rear portion adapted for detachably connecting to a pair of vertical members; and
wherein the longitudinal side portions are slidably and detachably connectable to each other by way of front and rear transverse members, and effective to accommodate the width size of any truck bed; and
wherein said rear portions are slidably and detachably connectable to said front portions of said longitudinal side portions and effective to accommodate the length size of any truck bed; and
wherein said bottom end portions of said vertical members are adapted to be securable to said truck bed longitudinal side apertures.

2. The rack assembly of claim 1 wherein said front portions of said longitudinal side portions when assembled and installed in a pickup truck bed form an overcab assembly.

3. The rack assembly of claim 1 wherein said slidably detachably connectable members are equipped with lockable means when in a connected mode.

4. The rack assembly of claim 3 wherein said lockable means is selected from a spring pin assembly, a bottom pin, and a bolt means.

5. The rack assembly of claim 1 wherein said vertical members are securable to said truck bed longitudinal side apertures by screw connection means associated therewith to releasably engage said truck bed.

6. A method for the fabrication of the truck rack assembly of claim 1.

7. A method for the fabrication of the truck rack assembly of claim 2.

8. A method for the fabrication of the truck rack assembly of claim 3.

9. A method for the fabrication of the truck rack assembly of claim 4.

10. A method for the fabrication of the truck rack assembly of claim 5.

11. A method for conducting an array of business functions comprising the use of the truck rack assembly of claim 1.

12. A method for conducting an array of business functions comprising the use of the truck rack assembly of claim 2.

13. A method for conducting an array of business functions comprising the use of the truck rack assembly of claim 3.

14. A method for conducting an array of business functions comprising the use of the truck rack assembly of claim 4.

15. A method for conducting an array of business functions comprising the use of the truck rack assembly of claim 5.
